(19) United States
(12) Patent Application Publication
(10) Pub. No.: US 2002/0082339 A1
(43) Pub. Date: Jun. 27, 2002

(54) Organopolysiloxane composition

(75) Inventors: Sun Yong Zhou, Taipei (TW); Shen Shou An, Taipei (TW); Du Qiang, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Silitek Corporation, Taipei (TW)

(21) Appl. No.: 09/925,256

(22) Filed: Aug. 9, 2001

(30) Foreign Application Priority Data
Dec. 21, 2000 (TW) 89127583

(51) Int. Cl. C08J 3/00

(52) U.S. Cl. 524/588

(57) ABSTRACT

An organopolysiloxane composition is provided, which has improved adhesive property with vulcanized silicone rubbers and high resistance to abrasion and friction, and can be used as a printing ink for rubber articles. The organopolysiloxane composition includes an organopolysiloxane having at least two Si-bonded vinyl radicals, an organopolysiloxane having at least three Si-bonded hydrogen atoms, an adhesion promoter containing organotitanium compound, a platinum catalyst and a reinforcing filler.

### FIELD OF THE INVENTION

The present invention relates to an organopolysiloxane composition, and more particularly to an organopolysiloxane composition containing an adhesion promoter.

### BACKGROUND OF THE INVENTION

Organopolysiloxane compositions are typically prepared to form elastomer by known methods such as liquid injection molding process. The liquid injection molding process is performed to produce silicone rubbers by mixing dimethylvinylsiloxy terminated polydimethylsiloxane with a reinforcing filler to form a mixture and then dividing the mixture into two parts: A and B. A solution of hexachloroplatinic acid in isopropyl alcohol as catalyst and optionally an inhibitor such as acetylene alcohol are added to part A. And trimethylsiloxy-terminated methylhydrosiloxane is added to part B. Subsequently, part A and part B are mixed in a weight ratio of 1:1 and left to be crosslinked at a temperature above 150°C. to be vulcanized into elastomers. However, such silicone rubber produced by the liquid injection molding process is not effectively adhesive to the vulcanized silicone rubber articles.

Although the typical organopolysiloxane composition has good self-adhesive property, such organopolysiloxane composition is not effectively adhesive to vulcanized silicone rubber articles.

Therefore, the present invention provides an organopolysiloxane composition for overcoming the problems described above.

### SUMMARY OF THE INVENTION

It is an object of the present invention to provide an organopolysiloxane composition capable of being vulcanized into elastomers.

It is another object of the present invention to provide an organopolysiloxane composition having improved adhesive property with vulcanized silicone rubbers and high resistance to abrasion and friction, and can be used as a printing ink for rubber articles.

In accordance with one aspect of the present invention, the organopolysiloxane composition contains 1-3% of organotitanium compound as adhesion promoter.

According to the present invention, the organopolysiloxane composition includes the following components:

(1) an organopolysiloxane having at least two Si-bonded vinyl radicals;

(2) an organopolysiloxane having at least three Si-bonded hydrogen atoms;

(3) an adhesion promoter containing organotitanium compound;

(4) a platinum catalyst; and

(5) a reinforcing filler.

The organopolysiloxanes having at least two Si-bonded vinyl radicals in accordance with the component (1) include the compound of formula I, II and III:

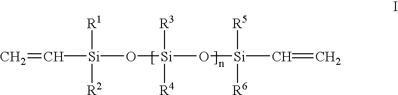

wherein each of R¹, R², R³, R⁴ , R⁵ and R⁶ is an alkyl radical selected from a group consisting of methyl, ethyl, n-propyl, isopropyl, n-butyl, isobutyl, tert-butyl, vinyl, phenyl, and 3,3,3-trifluoropropyl radical; when the R³ and R⁴ are different, the component (1) of formula I is a copolymer; n is an integer; and the viscosity of the component (1) is in the range from 10 Pa·s to 100 Pa·s at 25° C.

The organopolysiloxanes having at least two Si-bonded vinyl radicals in accordance with the component (1) of formula I include dimethylvinylsiliyl-terminated dimethylpolysiloxane, copolymer of dimethylvinylsiloxy-terminated dimethylpolysiloxane and methylvinylsiloxane, copolymer of dimethylvinylsiloxy-terminated dimethylpolysiloxane and diphenysiloxane, copolymer of dimethylvinylsiloxy-terminated dimethylpolysiloxane, diphenysiloxane and methylvinylsiloxane, copolymer of dimethylvinylsiloxy-terminated dimethylpolysiloxane, methylphenysiloxane and methylvinylsiloxane, dimethylvinylsiliyl-terminated methyl(3,3,3-trifluoropropyl)polysiloxane, copolymer of dimethylvinylsiloxy-terminated dimethyl polysiloxane and methyl(3,3,3-trifluoropropyl)siloxane, and copolymer of dimethylvinylsiloxy-terminated dimethyl polysiloxane, methyl(3,3,3-trifluoropropyl)siloxane and methylvinylsiloxane.

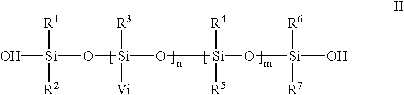

wherein each of R¹, R² , R³ , R⁴ , R⁵ , R⁶ and R⁷ is an alkyl radical selected from a group consisting of methyl, ethyl, n-propyl, isopropyl, n-butyl, isobutyl, tert-butyl, vinyl, phenyl and 3,3,3-trifluoropropyl radical; Vi is vinyl radical; n is an integer and greater than 2; m is an integer; and the viscosity of component (1) is in the range from 10 Pa·s to 100 Pa·s at 25° C.

The organopolysiloxanes having at least two Si-bonded vinyl radicals in accordance with the component (1) of formula II include dimethylhydroxysiloxy-terminated vinylpolysiloxane, copolymer of dimethylhydroxysiloxy-terminated dimethylsiloxane and methylvinylsiloxane, copolymer of dimethylhydroxysiloxy-terminated dimethylsiloxane, methylphenylsiloxane and methylvinylsiloxane, and copolymer of dimethylhydroxysiloxy-terminated dimethylsiloxane, diphenylsiloxane and methylvinylsiloxane.

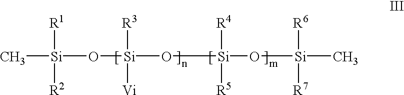

wherein each of R¹, R² , R³ , R⁴ , R⁵ , R⁶ and R⁷ is an alkyl radical selected from a group consisting of methyl, ethyl, n-propyl, isopropyl, n-butyl, isobutyl, tert-butyl, vinyl, phenyl and 3,3,3-trifluoropropyl radical; Vi is vinyl radical; n is an integer and greater than 2; m is an integer; and the viscosity of component (1) is in the range from 10 Pa·s to 100 Pa·s at 25° C.

The organopolysiloxanes having at least two Si-bonded vinyl radicals in accordance with the component (1) of formula III include trimethylsiliyl-terminated vinylpolysiloxane, copolymer of trimethylsiloxy-terminated dimethylsiloxane and methylvinylsiloxane, copolymer of trimethylsiloxy-terminated dimethylsiloxane, methylphenylsiloxane and methylvinylsiloxane, copolymer of trimethylsiliyl-terminated dimethylsiloxane, diphenylsiloxane and methylvinylsiloxane, copolymer of trimethysiliyl-terminated methyl(3,3,3-trifluoropropyl)siloxane and methylvinylsiloxane, copolymer of trimethysiliyl-terminated dimethylsiloxane, methyl(3,3,3-trifluoropropyl)siloxane and methylvinylsiloxane.

In accordance with the examples of organopolysiloxane described above, the preferable component (1) is one selected from a group consisting of dimethylvinylsiliyl-terminated dimethyl polysiloxane, dimethylhydroxysiliyl-terminated vinyl polysiloxane and trimethylsiliyl-terminated vinyl polysiloxane. More preferably, the component (1) is dimethylvinylsiliyl-terminated dimethyl polysiloxane, which is prepared by the reaction of octamethylcyclotetrasiloxane and 1,3-divinyltetramethyldisiloxane in the presence of basic catalysts such as KOH, NaOH, (CH₃)₄NOH, and (C₄H₉)₄POH or the acidic catalysts such as H₂SO₄ and trifluromethyl sulfonic acid.

The dimethylhydroxysiliyl-terminated dimethylsiloxane with varying degree of polymerization and with a viscosity in the range form 10 to 100Pa·s is prepared by adjusting the molar ratio of octamethylcyclotetrasiloxane and 1,3-divinyltetramethyldisiloxane. If the viscosity is lower than 10 Pa·s, the vulcanized elastomer has low strength. If the viscosity is greater than 100 Pa·s, the component (1) is difficult to be operated.

The organopolysiloxanes having at least three Si-bonded hydrogen atoms in accordance with the component (2) include the organopolysiloxanes of formula IV:

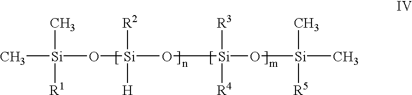

wherein each of R¹, R², R³, R⁴ and R⁵ is an alkyl radical selected from a group consisting of methyl, ethyl, n-propyl, isopropyl, n-butyl, isobutyl, tert-butyl, vinyl, phenyl, 3,3,3-trifluoropropyl radicals; n and m are integers; and the viscosity of the component (2) is in the range from 0.01 Pa·s to 50 Pa·s at 25° C. When R¹ and R² are hydrogen atom, n is at least 1. When one of R¹ and R² is hydrogen atom, n is at least 2. When neither R¹ nor R² is hydrogen atom, n is at least 3.

The examples in accordance with formula IV include trimethylsiloxyl-terminated methyl-H-polysiloxane, copolymer of trimethylsiloxyl-terminated dimethylsiloxane and methy-H-siloxane, dimethyl-H-siloxy-terminated methy-H-polysiloxane, copolymer of dimethyl-H-siloxy-terminated dimethysiloxane and methyl-H-siloxane, copolymer consisting of (CH₃)₂HSiO_{½} unit and SiO₂ unit, and copolymer consisting of (CH₃)₃SiO_{½} unit, (CH₃)₂HSiO_{½} unit and SiO₂ unit.

In accordance with the examples of organopolysiloxane described above, the preferable component (2) is trimethylsiloxy-terminated methyl-H-polysiloxane, which is usually prepared by the reaction of methylsichlorosilane hydrolysates and hexamethyldisiloxane in the presence of acidic catalyst. The acidic catalyst is preferably sulfuric acid or trifluoromethylsulfonic acid. The trimethylsiloxy-terminated methyl-H-polysiloxane has a yield greater than 1% and a viscosity in the range from 0.01 to 50 Pa·s.

The component (2) is readily reacted with vinyl radical in the presence of platinum catalyst, as shown in the following equation

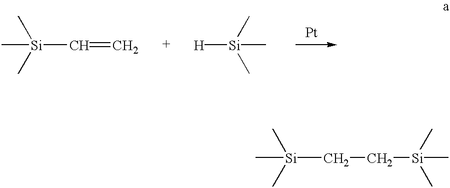

The adhesion promoter containing organotitanium compound in accordance component (3) is prepared by reacting n-butyl titanate (or iso-propyl titanate) with acetyl ethyl acetate as the following equation:

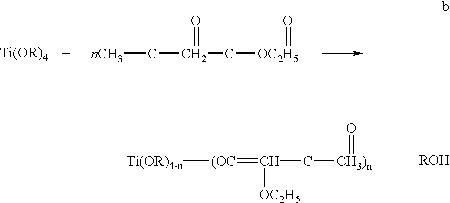

wherein, R is one of butyl radical and iso-propyl radical; n is an integer from 1 to 4; the molar ratio of Ti(OR)₄ to acetyl ethyl acetate is preferably in the range of 1:1 to 1:4, and more preferably 1:4. The increased quantity of acetyl ethyl acetate facilitates promoting the adhesion of the organopolysiloxane composition according to the present invention.

The content of the component (3) is in the range from 0.5 to 10% by weight, and preferably in the range from 1 to 3% by weight, based on total weight of component (1) and component (2). When the content is 15 below 0.5%, the adhesive property of the organopolysiloxane composition is not enough. However, when the content is greater than 10%, the cost is higher and activity of the platinum catalyst, i.e. the component (4), is inhibited.

The component (4) is a platinum catalyst which catalyzes the addition reaction of the organopolysiloxane having Si-bonded hydrogen atoms and the organopolysiloxanes having Si-bonded vinyl radicals. Generally, the complex of the Group VIII metal in the periodic table has catalytic effect on the reaction (a). In the present invention, the platinum catalyst is employed to catalyze the crosslinked reaction of the component (1) and the component (2). Such platinum catalyst is one selected from a group consisting of hexachloroplatinic acid, the mixture of hexachloroplatinic acid and alcohol, the mixture of hexachloroplatinic acid and ketone, the complex of hexachloroplatinic acid with olefin, the complex of hexachloroplatinic acid with vinylsiloxanes, the complex of hexachloroplatinic acid with diethyl o-phthalate. The preference is given to the complexes of hexachloroplatinic acid with vinylsiloxanes because the high activity thereof renders the addition reaction to carry out at room temperature.

The content of the component (4) is in the range from 0.1 to 100 ppm by weight, preferably in the range from 1 to 20 ppm by weight based on total weight of component (1) and component (2). When the content is below 0.1 ppm, the reaction will not be complete. However, when the content is greater than 100 ppm, the life of the composition will be reduced.

The component (5) is a reinforcing filler to increase the strength of the composition. Examples of the reinforcing fillers are pyrogenic silica or precipitated silica, and MQ silicon resin, which have good compatibility with the component (1), consistent viscosity and good reinforcing property. The MQ silicon resin is usually prepared by the following reaction of organopolysiloxane having mono-functional siloxane unit and silica hydro-gel in the presence of alcohol or carboxylic acid medium.

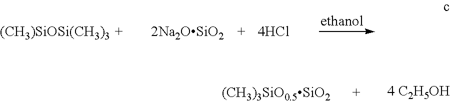

The MQ silicon resin can also be prepared by the following reaction of organopolysiloxane having mono-functional siloxane unit and tetrafunctional silicate in the presence of alcohol or carboxylic acid medium.

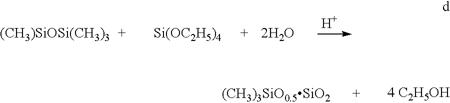

The content of the component (5) is in the range from 5 to 60% by weight, and preferably in the range from 10 to 40%, based on total weight of component (1) and component (2). When the content is below 5%, the reinforcing effect thereof is not enough. However, when the content is greater than 60%, the composition is too viscous to be operated.

In addition to the five components mentioned above, the composition in accordance with the present invention could further include other additive, for example inhibitors, pigments, organic solvents. The inhibitor is preferably acetylenic alcohol. Preferably, the pigment is a titanium white powder and the organic solvent is a coal oil.

### EXAMPLE 1

Preparation of Component (3)

0.68 kg of n-butyl titanate is introduced into a vessel equipped with a thermometer, a stirrer and a dropping funnel, and is stirred at room temperature. Subsequently, 1.04 kg of acetyl ethyl acetate is added dropwise into the vessel through the dropping funnel over a course of 0.5 to 1.0 hr. The n-butyl titanate and the acetyl ethyl acetate are continuously reacted for 5 hr and then heated to 90° C. The byproducts and volatile components, e.g. unreacted acetyl ethyl acetate are distilled off under atmospheric pressure. A red-brown product is obtained to serve as the component (3) of the present invention, i.e. the adhesion promoter.

### EXAMPLE 2

100 g of dimethylvinyl-terminated polydimethylsiloxane with a viscosity of 30 Pa·s, 3 g of trimethylsiloxane terminated methylhodrosiloxane with a viscosity of 0.01 Pa·s, 2.5 g of the resulting product of example 1, i.e. the adhesion promoter, 0.1 g of 1% hexachloroplatinic acid in iso-propanol and 100 g of coal oil are mixed and stirred, and then coated onto a vulcanized silicone rubber article at room temperature for 30 minutes. Subsequently, the vulcanized silicone rubber article is vulcanized at 200° C. for 10 minutes and cools to room temperature. When the crosslinked composition is stripped form silicone rubber article, a 100% of cohesive failure is found therebetween, which indicates that the composition of the present invention has good adhesive property to the vulcanized silicone rubber.

### Comparative Example 2

A mixture having the same components as in example 2 except for the adhesion promoter produced in example 1 is stirred and then coated onto a vulcanized silicone rubber article at room temperature for 30 minutes. Subsequently, the vulcanized silicone rubber article is vulcanized at 200° C. for 10 minutes and cools to room temperature. It is found that the crosslinked composition is easily stripped from the silicone rubber article.

### EXAMPLE 3

20 g of PART A(1990-40 PART A, Dow Corning, USA) with a viscosity of 70 Pa·s and 20 g of PART B(1990-40 PART B, Dow Coming, USA) with a viscosity of 70 Pa·s, 1 g of the resulting product of example 1, i.e. the adhesion promoter, 1 g of trimethylsiloxyl-terminated methylhydrosiloxane with a viscosity of 0.01 Pa·s, 32 g of R-960 titanium white powder, 0.05 g of 1% hexachloroplatinic acid in iso-propanol and 100 g of coal oil are mixed and stirred to obtain a viscous white paste. The white paste is printed onto a silicone rubber article via silk screen printing and stands at room temperature for 30 minutes. Subsequently, the silicone rubber article is heated at 200° C. for 10 minutes and cools to room temperature. It is found that the crosslinked composition is strongly bound on the silicone rubber article and has high resistance to abrasion and friction.

### Comparative Example 3

A mixture having the same components as in example 3 except for the adhesion promoter produced in example 1 is stirred to obtain a viscous white paste. The white paste is printed onto a silicone rubber article via silk screen printing and stands at room temperature for 30 minutes. Subsequently, the silicone rubber article is heated at 200° C. for 10 minutes and cools to room temperature. It is found that the crosslinked composition is easily stripped form the silicone rubber article.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An organopolysiloxane composition comprising the following components:
(1) an organopolysiloxane having at least two Si-bonded vinyl radicals with a viscosity in the range from 10 Pa·s to 100 Pa·s at 25° C.;
(2) an organopolysiloxane having at least three Si-bonded hydrogen atoms with a viscosity in the range from 0.01 Pa·s to 50 Pa·s at 25° C.;
(3) an adhesion promoter containing organotitanium compound, and adhesion promoter is in the range from 1 to 3% by weight based on total weight of said constitute (1) and said constitute (2);
(4) a platinum catalyst in the range from 1 to 20 ppm by weight based on total weight of said component (1) and said component (2); and
(5) a reinforcing filler in the range from 10 to 40%, based on total weight of said component (1) and said component (2).

2. The composition according to claim 1, wherein said component (1) comprises a compound having the formula I as follows: 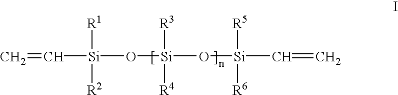
wherein each of R¹, R², R³, R⁴ , R⁵ and R⁶ is an alkyl radical selected from a group consisting of methyl, ethyl, n-propyl, isopropyl, n-butyl, isobutyl, tert-butyl, vinyl, phenyl and 3,3,3-trifluoropropyl radical and n is an integer.

3. The composition according to claim 2, wherein said compound is dimethylvinylsiliyl-terminated dimethylpolysiloxane.

4. The composition according to claim 1, wherein said component (1) comprises a compound having the formula II as follows: 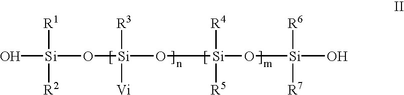
wherein each of R¹, R², R³, R⁴, R⁵, R⁶ and R⁷ is an alkyl radical selected from a group consisting of methyl, ethyl, n-propyl, isopropyl, n-butyl, isobutyl, tert-butyl, vinyl, phenyl and 3,3,3-trifluoropropyl radical; Vi is vinyl radical; n is an integer and greater than 2; and m is an integer.

5. The composition according to claim 4, wherein said compound is dimethylhydroxysiliyl-terminated vinylpolysiloxane.

6. The composition according to claim 1, wherein said component (1) comprises a compound having the formula III as follows: 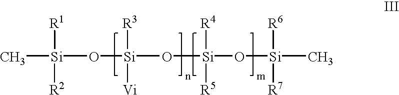
wherein each of R¹, R², R³, R⁴, R⁵, R⁶ and R⁷ is an alkyl radical selected from a group consisting of methyl, ethyl, n-propyl, isopropyl, n-butyl, isobutyl, tert-butyl, vinyl, phenyl and 3,3,3-trifluoropropyl radical; Vi is vinyl radical; n is an integer and greater than 2; and m is an integer.

7. The composition according to claim 6, wherein said compound is trimethylsiliyl-terminated vinyl polysiloxane.

8. The composition according to claim 1, wherein said component (2) comprises a compound having the formula IV as follows: 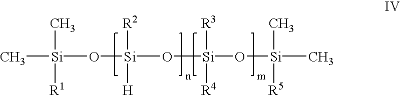
wherein each of R¹, R², R³, R⁴ and R⁵ is an alkyl radical selected from a group consisting of methyl, ethyl, n-propyl, isopropyl, n-butyl, isobutyl, tert-butyl, vinyl, phenyl and 3,3,3-trifluoropropyl radical; n is an integer; and m is an integer.

9. The composition according to claim 8, wherein said compound is one selected from a group consisting of trimethylsiloxyl-terminated methy-H-polysiloxane, copolymer of trimethylsiloxyl-terminated dimethylsiloxane and methyl-H-siloxane, dimethyl-H-siliyl-terminated methyhyl-H-polysiloxane, copolymer of dimethylsiloxyl-terminated dimethysiloxane and methy-H-siloxane, copolymer consisting of (CH₃)₂HSiO_{½} unit and SiO₂ unit, and copolymer consisting of (CH₃)₃SiO_{½} unit, (CH₃)₂HSiO_{½} unit and SiO₂ unit.

10. The composition according to claim 1, wherein said component (3) is prepared by reacting one of n-butyl titanate and iso-propyl titanate with acetyl ethyl acetate, said component (3) having a formula as follows: 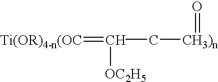
wherein R is one of butyl radical and iso-propyl radical; n is an integer from 1 to 4; and the molar ratio of Ti(OR)₄ to acetyl ethyl acetate is in the range of 1:1 to 1:4.

11. The composition according to claim 1, wherein said component (4) is a compound selected from a group consisting of hexachloroplatinic acid, a mixture of hexachloroplatinic acid and alcohol, a mixture of hexachloroplatinic acid and ketone, a complex of hexachloroplatinic acid with olefin, a complex of hexachloroplatinic acid with vinylsiloxanes and a complex of hexachloroplatinic acid with diethyl o-phthalate.

11. The composition according to claim 1, wherein said component (5) is one selected from a group consisting of pyrogenic silica, precipitated silica and MQ silicon resin.

12. The composition according to claim 1, further comprising an additive selected from a group consisting of an inhibitor, a pigment and an organic solvent.

13. The composition according to claim 12, wherein said inhibitor is acetylenic alcohol.

14. The composition according to claim 12, wherein said pigment is a titanium white powder.

15. The composition according to claim 12, wherein said organic solvent is a coal oil.
